(19) United States
(12) Patent Application Publication
(10) Pub. No.: US 2007/0200336 A1
(43) Pub. Date: Aug. 30, 2007

(54) Expandable business card

(76) Inventor: Richard Wilen, Deerfield Beach, FL (US)

Correspondence Address: Stephen E. Feldman, 12 East 41st. Street, New York, NY, 10017, US

(21) Appl. No.: 11/365,071

(22) Filed: Feb. 28, 2006

(51) Int. Cl. B42D 15/00

(52) U.S. Cl. 283/74

(57) ABSTRACT

An expandable business card is described that includes a first foldable page and a second foldable page. The first foldable page has a detachable business card. The second foldable page is connected to a booklet. The first page and second page are interconnected and slidingly engaged. When in a fir st folded position, the booklet is concealed within the perimeter of the expandable business card. When the expandable business card is opened in the second position, the booklet can expand to a predetermined size to provide an additional area for promotional information. The first page includes a projection that is not visible in the first folded position but then extends for viewing in the second open position.

### FIELD OF THE INVENTION

The present invention relates to business cards and more specifically to business cards that can expand and provide additional surface area for the presentation of information.

### BACKGROUND OF THE INVENTION

Foldable objects provide individuals with devices that can provide additional information compared to those that are simply two sided. Examples include booklets, such as U.S. Pat. No. 6,752,427 to Wilen, that defines a plurality of longitudinal panels that enclosed by an outer cover.

Business cards are a representation of an individual and yet provide only a limited amount of area for that representation. Many businesses, such as those related to art and advertising, are highly creative and desire to:expand the amount of information that can be communicated by the traditional two sided business card formats.

A business card is needed that can expand and can provide a range of different kinds of information to the holder of the card.

### SUMMARY OF THE INVENTION

The preferred embodiment of the present invention is an expandable business card that comprises a first page that includes a fold that joins two panels. A first panel includes a detachable portion. The second panel includes a projection. The first page has an inner side and an outer side. A second page has four sides and includes three panels joined by two folds. A slot is defined in one of the folds. The second page has an inner side and an outer side. The outer side of the second page is connected to the inner side of the first page. A booklet is attached to the inner side of the second page. The business card has a first closed position in which the first panel of the second page is a cover and the detachable portion is a business card. The third panel of the second page is an opposed cover. The projection is at least partially concealed. A second position of the expandable business card includes the covers opened to show the booklet and the projection.

The expandable business card wherein the second page has a first panel positioned under the first panel of the first page and the first panel of the second page includes a business card. The expandable business card in the second position includes the projection extending through the slot in the fold of the second page. The projection has two opposed sides and at least one of the sides of the projection can include at least one of text, an image and a graphic.

The booklet in the second position includes two viewable panels and is positioned inside the perimeter of a first panel and a second panel of the second page. The booklet can expand to a third position that includes four viewable panels. The booklet can expand to a fourth position that includes eight viewable panels. The expandable business card includes a second cover opposite the first cover that can function as a cover for the booklet.

In another embodiment, the expandable business card comprises a first page that includes a first panel detachable from a second panel along perforations. A fold joins the second panel and a third panel. The third panel projects from the second panel. The first page has an inner side and an outer side. A second page includes three panels joined by two folds. A slot is defined in one of the folds. The first page has an inner side and an outer side. The outer side of the second page is connected to the inner side of the first page. A booklet is connected to the inner side of the second page. A first position of the expandable business card includes the expandable business card in a closed position. The first panel of the second page is a cover that includes, for example, a detachable business card. The third panel of the second page is the opposed cover for the booklet. The projection and the booklet are at least partially concealed in the first closed position. A second position wherein the covers are opened to view the at least partially unfolded booklet. At least a portion of the third panel extends through the slot in the fold of the second page and is viewable. The booklet is positioned within the outer edges of the first panel and second panel of the second page. A third position wherein the booklet unfolds such that at least a portion of the booklet extends beyond the edges of the second page.

The expandable business card of claim wherein the booklet unfolds into a fourth position that is greater than the size of the second position. The expandable business card has a height of approximately 3.5 inches when viewed as booklet. The expandable business card has a width of approximately 2.9 inches when viewed as a booklet. The expandable business card of claim 9, wherein the expandable business card has a depth of approximately 0.1 inch.

### BRIEF DESCRIPTION OF THE DRAWINGS

Preferred embodiments of the invention are described below with reference to the drawings, wherein like numerals are used to refer to the same or similar elements.

FIG. 1 is a top frontal perspective view of an expandable business card of the present disclosure;

FIG. 2 is a plan view of a first page of the expandable business card of FIG. 1;

FIG. 3 is a plan view of a second page of the expandable business card of FIG. 1;

FIG. 4 is a top rear perspective view of a first page of the expandable business card of FIG. 1;

FIG. 5 is a plan view of the opened expandable business card of FIG. 1 in a first expanded position showing a booklet;

FIG. 6 is a plan view of the booklet of the expandable card of FIG. 5, in a second expanded position; and

FIG. 7 is a plan view of the booklet of the expandable card of FIG. 5, in a third expanded position.

### DETAILED DESCRIPTION

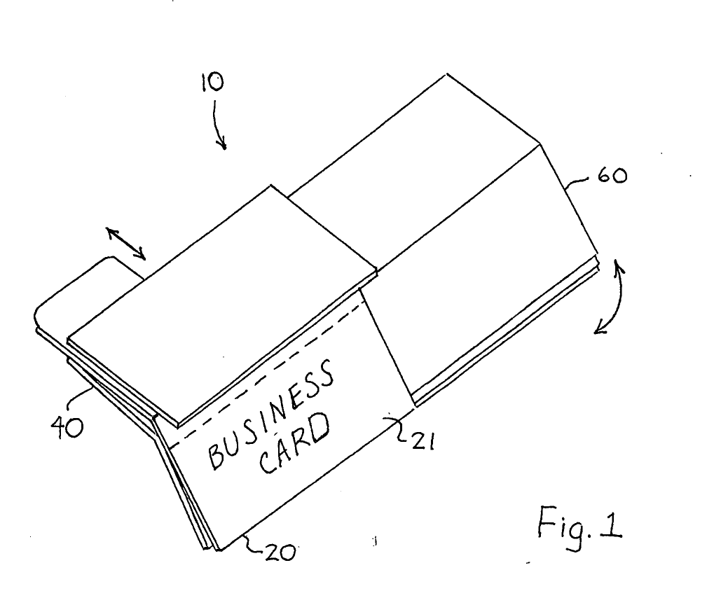

Referring to FIG. 1, the preferred embodiment of an expandable business card 10 includes a first page 20, a second page 40 and a booklet 60. First page 20 and second page 40 are connected and interrelated. Booklet 60 is connected to second page 40. Expandable business card 10 can advantageously expand to provide additional surface areas for the positioning of images, graphics and/or trademarks associated with the cardholder and/or the cardholder's business.

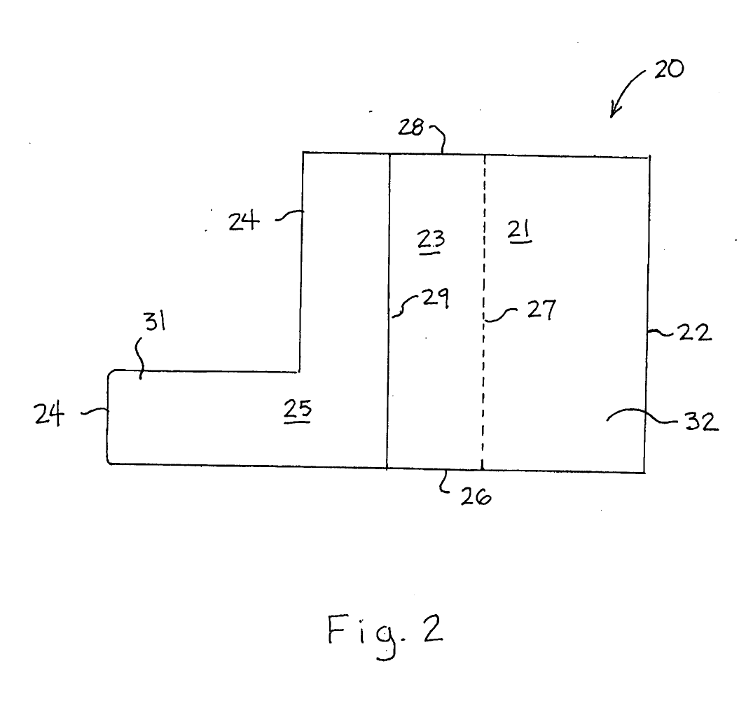

As shown in FIG. 2, first page 20 has a first edge 22 opposed by a second edge 24 and a third edge 26 opposed by a fourth edge 28. First page 20 includes a first panel 21, a second panel 23 and a third panel 25. First panel 21 and second panel 23 are preferably separated by perforations 27. First panel 21 is preferably a business card that can be readily separated from second panel 23 by tearing along perforations 23. The bottom of the business card includes edge 22 and the sides include a portion of opposed edges 26 and 28.

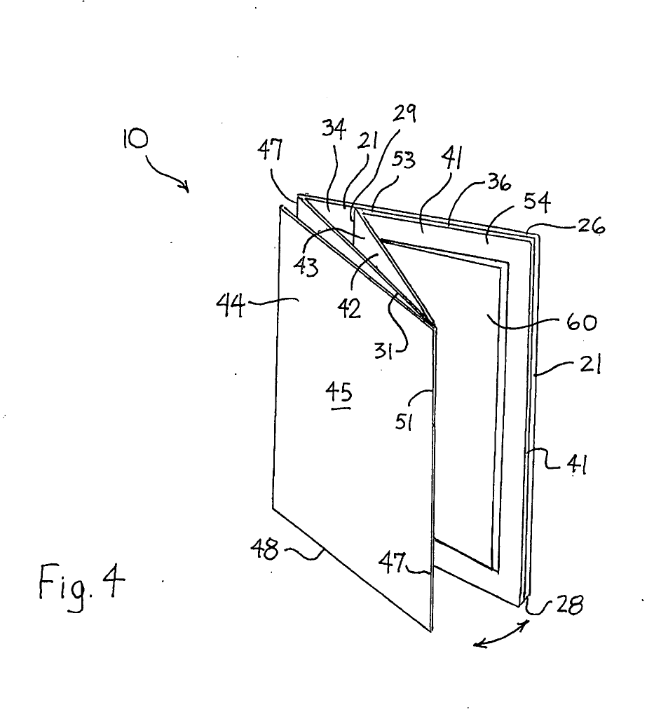

Third panel 25 is connected to second panel 23 by a fold 29. The second panel includes a projection 31. The terminal end of projection 31 includes an outer portion of second edge 24 that forms a corner with edge 26. Second edge 24 has an inner portion that forms a corner with edge 28 and is connected to projection 31. In this preferred embodiment first edge 22, second edge 24, perforations 23 and fold 29 are approximately parallel. First page 20 has a first side 32 opposed by a second side 34 (See FIG. 4).

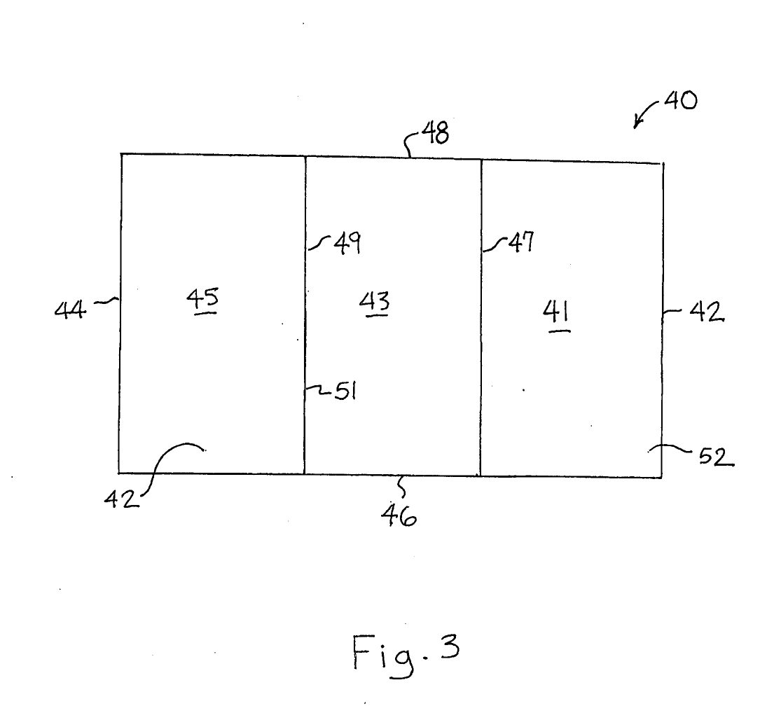

Referring now to FIG. 3, second page 40 includes a first edge 42 opposed by a second edge 44 and a third edge 46 opposed by a fourth edge 48. Second page 40 has a first panel 41, a second panel 43 and a third panel 45. A first fold 47 separates the first panel 41 and the second panel 43. A second fold 49 separates the second panel 43 and third panel 45. First panel 41 can include a detachable or non-detachable business card.

In the preferred embodiment, first fold 47 includes a slot 51. Slot 51 can be a cut along a portion of fold 47 that preferably runs a predetermined distance in an inward direction from edge 46 or a hole in portions of panels 43 and/or 45. As required, fold 47 can also include reinforcing to ensure the long term integrity of the connection of panels 41 and 43. Second page 40 also includes an outer side 52 and an inner side 54 (See FIG. 4).

In the preferred embodiment, edges 26 and 28 and 46 and 48 are approximately parallel and have a fixed dimensional distance between the respective edges such that edges 26 and 46 and 28 and 48 can be aligned. Similarly, edges 22 and 42 and edges 24 and 44 are parallel and edges 22 and 42 and edges 24 and 44 can each be aligned to form a single combined edge.

As shown in FIG. 4, expandable business card 10 is in a position in a partially open position in which booklet 60 is folded and/or unexpanded within the perimeter of pages 20 and 40. Business card 10 has a first unexpanded position in which fold 47 and edges 41 and 21 are in close proximity and edge 44 is in apposition with fold 47. Card 10, as shown, has edges 28 and 48 directed downward such that card 10 is positioned like a miniature book. Portions of second sides 34 and 44 of first page 20 and second page 40 are viewable in this position. Projection 51 is partially hidden from view between first side 42 of panels 43 and 45.

Expandable business card 10 in this one preferred embodiment has dimensions that are approximately 3.5 inches in height, approximately 2.875 inches in width and approximately 0.125 inches in depth when fully folded and unexpanded. It is understood that the external dimensions of expandable business card 10 can vary depending upon the desired application, but is intended to be sized such that it can easily carried in a wallet, purse or pocket. Expandable business card 10 is preferably made of paper or paper based products, but can also include plastics or composite materials. The folds of page 20, page 40 and booklet 60 can be preformed flexible hinges or include a separate connecting hinge.

First side 42 and second side 34 preferably have a connection 53 made by an adhesive that extends in a line or strip approximately between edges 26, 36 and edges 28, 48. Connection 53 is preferably approximately parallel to and positioned in proximity to fold 47. Connection 53 places fold 47 and fold 29 at a predetermined fixed distance that functions to slidingly engage pages 20 and 40 to retract projection 31 in the folded or closed position and extend projection 31 in any of the expanded positions. Alternative methods for connecting include common fasteners such as staples, as well as heat bonding. Booklet 60 is attached to second side 44 of panels 41 and 43.

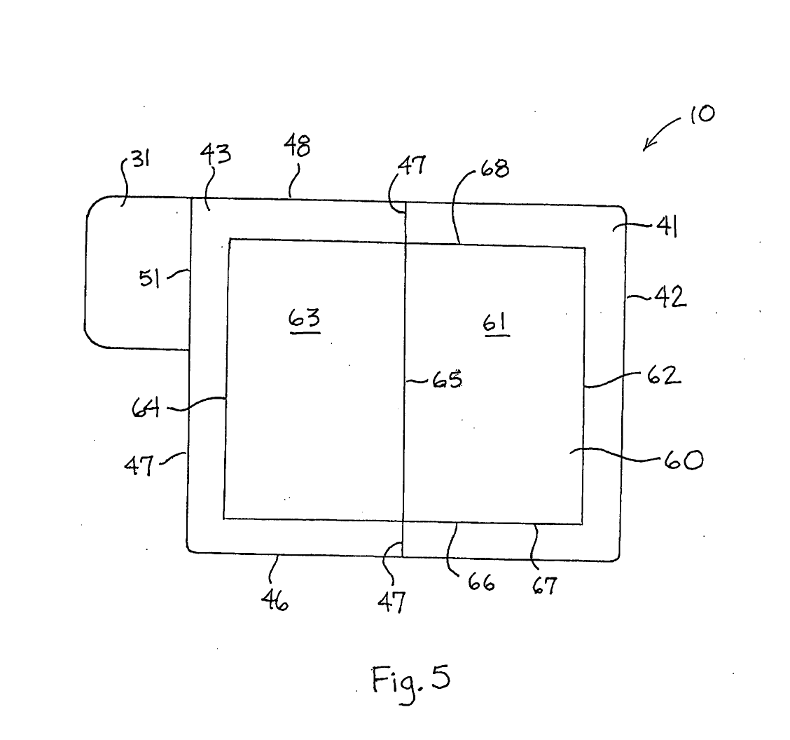

In operation, referring now to FIGS. 4 and 5, as expandable business card 10 is unfolded or expanded about fold 47 the fixed relationship of pages 20 and 40 and position of fold 29 relative to fold 47 and connection 53 extends projection 31 through slot 51. In this position at least a portion panel 45 and edge 44 extends over panel 41. As card 10 is moved into a first expanded position, panel 41, panel 43, booklet 60 and projection 31 are shown. Business card 10 unfolds or expands about connection 53 and fold 47.

Referring now to FIG. 5, booklet 60 in the first expanded position includes a first side 62, an opposed second side 64, a third side 66 and an opposed fourth side 68. Booklet 60 in this position has two panels 61 and 63. A first fold 65 separates panels 61 and 63 and is aligned with fold 47. Side 64 includes a third fold 69. The opening of expandable business card 10 extends projection 31 through slot 51 and provides an eye catching additional viewable surface for an advertisement; image and/or trademark. The folded dimensions of booklet 60 in the first expanded position are less than that of edges 42, fold 47, edge 46 and edge 48 of second page 40.

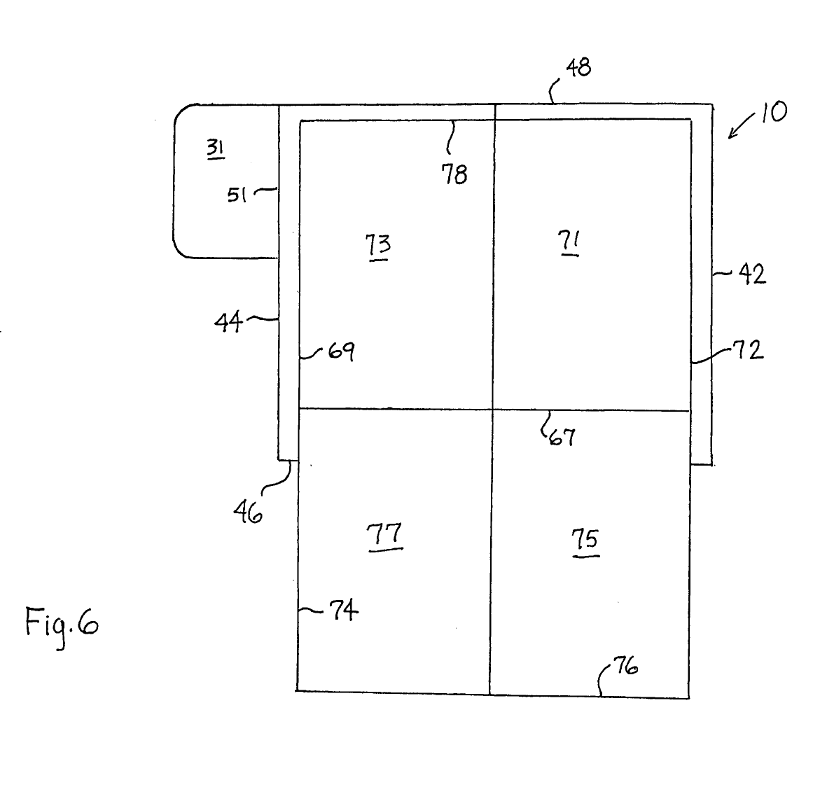

As shown in FIGS. 5 and 6, booklet 60 has unfolded and/or expanded into a second expanded position that includes unfolding along a fold 67 to show a first page of booklet 60 that has panels 71, 73, 75 and 77. The booklet 60 may contain up to thirty-two pages depending on the weight and thickness of the paper used. Booklet 60 in this second expanded position includes a first side 72, an opposed second side 74, a third side 76 and an opposed fourth side 78. Second fold 67 is preferably approximately parallel to edges 46 and 48 and can be either in proximity to edge 46 or edge 48. Panels 75 and 77 in this preferred embodiment extend beyond edge 46, but the remainder of booklet 60 preferably remains inside of edges 42, 44.and 48. Booklet 60 can also include a third fold 69 on side 64 that is now fully extended. This position provides a further expansion of surface area for text, images and advertising.

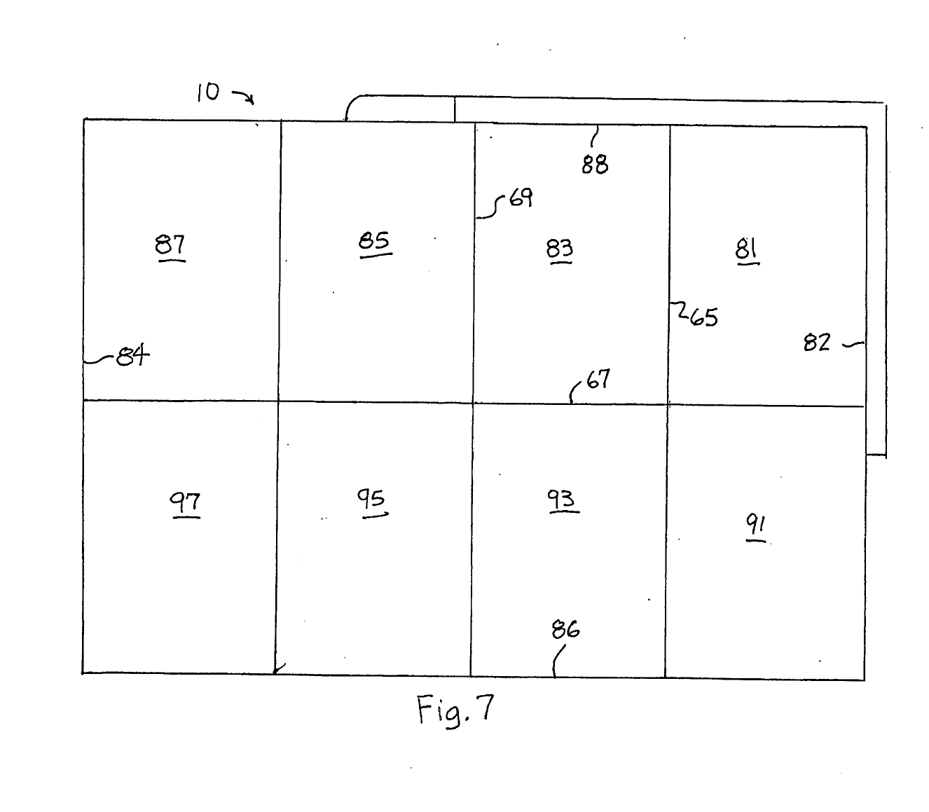

Referring now to FIGS. 6 and 7, booklet 60 has unfolded and/or expanded into a third expanded position that includes unfolding along fold 69 to show a third page of booklet 60 that has panels 81, 83, 85, 87, 91, 93, 95 and 97. Booklet 60 in this third expanded position includes a first side 82, an opposed second side 84, a third side 86 and an opposed fourth side 88. Booklet 60 can have a single page or multiple pages (up to thirty-two pages depending on the weight and thickness of the paper) each having one or more panels. In this third expanded position, booklet 60 extends beyond edges 44 and 46, but preferably remaining inside of edges 42 and 48.

Expandable business card 10 is returned to the first unfolded position by folding booklet 60 about folds 69 and 67. Booklet 60 is then conveniently stored within the outer covers of expandable business card 10 and reduced to a convenient carrying size.

It is understood that while booklet 60 is described as having three positions for unfolding, booklet 60 can expand in a range from only the first expanded position to a plurality of expanded positions depending upon the desired application. Similarly, booklet 60 can include different quantities of folds that unfold or expand in differing directions that are also considered variations within the scope of the present disclosure.

In the preceding specification, the invention has been described with reference to specific exemplary embodiments thereof. It will however, be evident that various modifications, combinations and changes may be made thereto without departing from the broader spirit and scope of the invention as set forth in the claims that follow. For example, the external shape of expandable business card 10 can vary to provide a range of eye catching shapes and still retain the present functions. The specification and drawings are accordingly to be regarded in an illustrative manner rather than a restrictive sense.

What is claimed is:

1. An expandable business card that comprises:
a first page, the first page including a fold that joins a first panel and a second panel, the first panel including a detachable portion, the second panel including a projection, the first page having an inner side and an outer side;
a second page, the second page including four sides, three panels joined by two folds, and a slot defined in one of the folds, the second page having an inner side and an outer side, the outer side of the second page being connected to the inner side of the first page; and
a booklet attached to the inner side of the second page, whereby said business card includes a closed position and an open position, the closed position wherein the first panel of the second page is a cover and the detachable portion is a business card, the third panel of the second page is an opposed cover, and the projection is at least partially concealed, and the open position wherein the covers are opened to show the booklet and the projection.

2. The expandable business card of claim 1, wherein the second page has a first panel positioned under the first panel of the first page and the first panel of the second page includes a business card.

3. The expandable business card of claim 2, wherein the business card on the second page is detachable.

4. The expandable business card of claim 1, wherein the projection has two opposed sides and at least one of the sides of the,projection includes at least one of text, an image and a graphic.

5. The expandable business card of claim 1, wherein the booklet in the open position includes two viewable panels and the booklet is inside the perimeter of a first panel and a second panel of the second page.

6. The expandable business card of claim 1, wherein the booklet has expanded to a third position that includes four viewable panels.

7. The expandable business card of claim 1, wherein the booklet has expanded to a fourth position that includes eight viewable panels.

8. The expandable business card of claim 1, wherein the opposed cover is a cover for the booklet.

9. The expandable business card of claim 1, wherein the booklet may have up to thirty-two pages.

10. An expandable business card that comprises:
a first page that includes a first panel detachable from a second panel along perforations, a fold that joins the second panel and a third panel, the third panel projects from the second panel, the first page has an inner side and an outer side;
a second page that includes three panels joined by two folds, a slot defined in one of the folds, the first page has an inner side and an outer side, the outer side of the second page connected to the inner side of the first page;
a booklet connected to the inner side of the second page;
whereby the business card includes a first position wherein the expandable business card is closed and the first panel of the second page is a cover that includes a detachable business card and the third panel of the second page is the opposed cover for the booklet, the projection and the booklet at least partially concealed, and a second position wherein the covers are opened to view the at least partially unfolded booklet, at least a portion of the third panel extended through the slot in the fold of the second page and viewable, the booklet positioned within the outer edges of the first panel and second panel of the second page, and a third position wherein the booklet unfolds such that at least a portion of the booklet extends beyond the edges of the second page.

11. The expandable business card of claim 10, wherein the booklet unfolds into a fourth position that is greater than the size of the second position.

12. The expandable business card of claim 10, wherein the expandable business card has a height of approximately 3.5 inches when viewed as booklet.

13. The expandable business card of claim 10, wherein the expandable business card has a width of approximately 2.875 inches when viewed as a booklet.

14. The expandable business card of claim 10, wherein the expandable business card has a depth of approximately 0.125 inches.

15. The expandable business card of claim 10, wherein the booklet may have up to thirty-two pages.
